(19) United States
(12) Patent Application Publication
(10) Pub. No.: US 2006/0129935 A1
(43) Pub. Date: Jun. 15, 2006

(54) Integrated information management system and method

(75) Inventors: John J. Deinlein, Odenton, MD (US); Robert F. Bote, Ellicott City, MD (US); Joseph A. Williams, Crofton, MD (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/011,946

(22) Filed: Dec. 15, 2004

(51) Int. Cl. G06F 3/00

(52) U.S. Cl. 715/733

(57) ABSTRACT

Embodiments of present invention provide a portal to various applications to allow for easy and quick access to data. In some embodiments, a portal is configured to provide access to the data required to manage, create, and oversee contract data related to one or more programs for a government agency. In particular, the portal may provide a virtual workspace that includes access to one or more applications. Some of the applications may be predetermined or “built-in” as part of the virtual workspace. The portal may include access to other applications to suit the requirements, for example, of a particular government agency. In addition, the portal may support a single sign-on feature and enforce role based security for the applications.

### DESCRIPTION OF THE INVENTION

1. Field

This invention relates to systems and methods for integrated information management. In particular, the present invention relates to systems and methods that provide an integrated interface that is capable of accessing a variety of applications.

2. Introduction

Government agencies typically require a wide variety of information technology to support their operations. Conventionally, government agencies have hired an outside contractor as part of a program to implement one or more separate information system for their operations. For example, a typical agency of the federal government may have various programs that use separate systems for financial management, procurement, property management, project management, etc. These systems may have been custom-built for the government agency or based on commercial-off-the-shelf (COTS) products implemented by the outside vendor.

Ideally, the disparate computer systems of a government agency should easily operate with each other. Unfortunately, integrating these disparate, but related systems of a government agency can be difficult. For example, a government agency may use a legacy system that uses data protocols that are incompatible with newer systems. In addition, even if the same agency is involved, systems from different programs may be incompatible with each other. Some government agencies have attempted to create custom interfaces between various systems. However, these types of interfaces are difficult to maintain. In other instances, government agencies have resorted to replicating its data across multiple systems. This approach is labor intensive and prone to errors.

Therefore, it would be desirable to provide an integrated information management system that is capable of working with a variety of systems, such as those used by government agencies. In addition, it would be desirable to provide methods and systems that provide data accuracy, timeliness, and easy access to the data of a government agency.

### SUMMARY

In accordance with embodiments of the present invention, an integrated information management system comprises a set of predetermined applications related to managing information of a government program, and a web portal that renders a set of web pages that are linked to each of the set of predetermined applications.

In accordance with other embodiments of the present invention, a method of integrating management of information related to government programs is provided. An integrated interface is provided that is interoperable with at least a set of predetermined applications that are related to at least one government program at a location accessible from a public network. Users are then permitted access to the set of predetermined applications through the integrated interface based on information identifying the user and actions requested by the user that are communicated over the public network.

In accordance with other embodiments of the present invention, a portal for integrating management of information related to government programs is provided. The portal comprises a processor and a memory for storing program code capable of configuring the processor. The program code comprises program code for interoperating with a set of predetermined applications that are common to a plurality of government programs and program code for serving web pages that include content from the set of predetermined applications.

Additional features of the invention will be set forth in part in the description which follows, and in part will be obvious from the description, or may be learned by practice of the invention. It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several embodiments and features of the invention and together with the description, serve to explain the principles of the invention.

FIG. 1 shows an exemplary system that is consistent with embodiments of the present invention;

FIG. 2 shows an exemplary hierarchy of web pages that may be provided by a portal that is consistent with embodiments of the present invention;

FIG. 3 shows exemplary templates for the web pages of FIG. 2; and

FIG. 4 shows an exemplary web page that is based on a template shown in FIG. 3.

### DESCRIPTION OF THE EMBODIMENTS

Embodiments of present invention provide a portal to various applications to allow for easy and quick access to data. For example, in some embodiments, a portal is configured to provide access to the data required to manage, create, and oversee contract data related to one or more programs for a government agency. Reference will now be made in detail to exemplary embodiments of the invention, examples of which are illustrated in the accompanying drawings. Wherever possible, the same reference numbers will be used throughout the drawings to refer to the same or like parts.

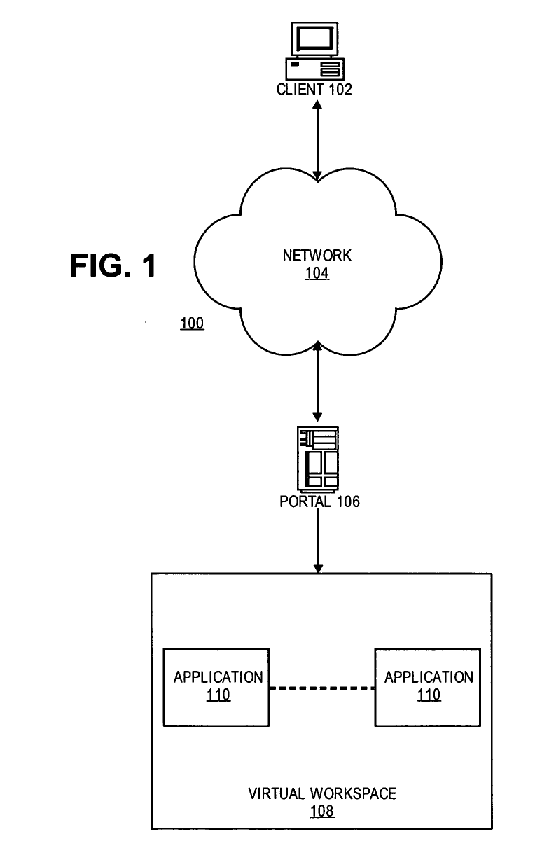

FIG. 1 shows a system 100 that is consistent with embodiments of the present invention. As shown, system 100 may comprise a client 102, a network 104, and a portal 106. The components of system 100 may be implemented on separate devices that are known to those skilled in the art. For example, client 102 may be implemented on a single device, such as a personal computer. Likewise, portal 106 may be implemented on a single machine that runs under a common operating system, such as Linux or Unix. Alternatively, portal 106 may be implemented on multiple machines that run different operating systems.

In addition, system 100 may also include other components that are not shown. For example, system 100 may include a firewall (not shown) between network 104 and portal 106. Such firewalls are well known to those skilled in the art. Other types of network elements or components may also be included in system 100, such as routers, switches, hubs, etc. The components shown in FIG. 1 will now be further described.

Client 102 provides a user interface for system 100. Client 102 may be implemented using a variety of devices and software. For example, client 102 may be implemented on a personal computer, workstation, mobile phone, PDA, or terminal. In addition, client 102 may run under the well known Windows operating system and interface portal 106 through a browser application, such as Internet Explorer by Microsoft Corporation or Netscape Navigator by Netscape Communications Corporation. Although FIG. 1 shows a single client, system 100 may include any number of clients.

Network 104 provides a communications infrastructure for system 100. For example, client 102 and portal 106 may communicate with each other over network 104 using known protocols, such as the transport control protocol and internet protocol (TCP/IP), hypertext transport protocol (HTTP), common gateway interface (CGI), extensible markup language (XML), and Java database connectivity (JDBC). Of course, network 104 may be configured to support any type of network communications and protocol. Network may itself comprise one or more networks, such as a local area network, wide area network, or the Internet.

Portal 106 serves as a common access point to various applications that are related, for example, to programs of a government agency. Portal 106 may be implemented with well known components, such as a web server that delivers a hypertext markup language document (i.e., a HTML web page) over network 104. For example, portal 106 may be accessible at a single uniform resource locator (URL) address of network 104 and integrate disparate, but related databases and systems of a government agency. Accordingly, in some embodiments, portal 106 may be accessible from any location coupled to the Internet.

In order to facilitate the interface to various applications, portal 106 may provide one or more virtual workspaces for an organization, such as virtual workspace 108. Virtual workspace 108 can be provided for any level of an organization, such as a government agency. In turn, virtual workspace 108 may provide access to one or more of applications 110.

In order to facilitate the access to applications 110, portal 106 may provide a single sign-on capability to applications 110. For example, users of portal 106 may be required to fill out an enrollment form to collect the system and user access permissions of each user. Portal 106 may then be configured to implement the information indicated in the enrollment form. Alternatively, portal 106 may include one or more servers, such as a single sign-on server, that implements a user's access permission in an interactive database, which is then distributed to individual systems. Portal 106 may also provide security that ensures users can only access data they need and are authorized to access. For example, in those embodiments related to government agencies, security groups may be defined in portal 106 to protect data by contract, customer, internal employees, subcontractors, external customers, and by task order. Portal 106 may enforce role based security policies to provide fine grained access control from page to even an item level in virtual workspace 108. Therefore, users may be restricted from accessing certain portions of virtual workspace 108 or applications 110 based on their privileges or current role.

In some embodiments, portal 106 may implement virtual workspace 108 in the form of an online web service or web site that are linked to applications 110. These links to applications 110 may be based on one or more of known types of web services. In order to integrate applications 110 into virtual workspace 108, portal 106 may include software or hardware that bridge custom-built, local, and COTS tools together. Accordingly, portal 106 may interoperate or link with a wide variety of applications, even the application is hosted at a location that is separate from portal 106. For example, in some embodiments, portal 106 may include known products, such as those from Oracle Corporation, Documentum, Maximo, etc. that are integrated together as part of virtual workspace 108. These known products may be integrated together with portlets or custom code, such as structured query language code (SQL), that are known to those skilled in the art.

For example, for those embodiments that are based on Oracle products, a portlet may be a “stoplight” icon that can be displayed on client 102. Clicking on this stoplight may then open a detailed checklist and allow updates by an approved user of system 100. Other known portlets that may be implemented in portal 106 may include: self-service content management tools available to build content driven portlets; portlets to support document and content uploads for files, such as HTML, text, images, URL's; portlets to display spreadsheets, XML documents, and web service data as tabular, chart, news, bullet, and form layouts; a web clipping portlet; a portlet that allows user to list favorite links; a search portlet to allow users to specify customizable searches; a notification portlet; a status portlet, a database portlet; a database navigator portlet; a schema editor to create or edit database schemas; a roles editor to create or edit database roles; database information tools to list statistics about database settings and parameters, database memory consumption, transactions, locks, and database storage; tools to list status and results for background applications; an external applications tool that allows for links to external applications; a login tool to allow logins directly from a page on portal 106; a single sign-on (SSO) server administration tool that configures partner and external applications for authentication through an SSO server (not shown in FIG. 1), and edits the SSO server configuration; a tool for creating or editing users for single sign-on sessions through portal 106; a tool that can create or edit user groups in a directory maintained by portal 106; a people search tool for looking up users in a directory; a portal group profile tool that allows a user to edit the portal profile for a group and assign portal global privileges to the group and establish portal properties for the group; and a portal user profile that allows editing of a portal user's profile including the assignment of global portal privileges and user defaults.

Furthermore, portal 106 may provide various tools to implement the functions of virtual workspace 108. For example, such tools may include: a mobile XML portlet to create or edit content; a set language tool that lists the available languages in which portal content can be displayed and allows a user to select the language to display from portal 106; a HTML portlet that allows a user to create or edit content in virtual workspace 108 by entering HTML; a recent objects tool that allows a user to list objects in virtual workspace 108 that were recently modified; a repository to tool to refresh all the portlets used in virtual workspace 108 or refresh a provider in the repository; a search tool to search for objects in portal 106. Other functions that virtual workspace 108 may provide include: a workflow notifications application that displays notifications and provides features like notification reassigning, customizing, sorting, etc.; an email client; a language tool that allows a user to constrain the amount of languages, set a default language, etc.; a poll tool that allows a user to cast votes on various issues, for example, on a particular issue in workspace 108, create questions and choices for a poll; a photo viewing application that provides a picture viewer for photos and drawings stored in portal 109 (this application can be configured to generate HTML so that any browser can scroll through photos, and select photos from thumbnails, magnify a photo or view a slideshow); an application that is based on iFrame technology and also takes advantage of single sign-on features provided by portal 106; a newsfeed application that allows the user to customize and selecting a newsfeed source, for example, from a pick list; a navigation tool that provides a Windows Explorer type navigation through pages displayed by portal 106; a tool that allows for automatic login from Windows to portal 106; a portlet that allows a user to initiate a telnet session with a server; a discussion forum application that allows user to create and participate in various discussion threads on portal 106; a calendar application; a search portlet that searches the internet using known engines from Yahoo, Altavista, Excite, and Google; and an interface for integrating with various other applications, such as Microsoft Exchange and Lotus Notes.

In some embodiments, virtual workspace 108 may include various communications tools, such as forums or electronic rooms that are categorized by function, by project, or by task order. Virtual workspace 108 may also include other communications tools, such as tools for central announcements, alerts, status reports, and project calendars. Virtual workspace 108 may also include collaboration and knowledge management tools, such as discussion threads, and content management systems with metadata.

In some embodiments, virtual workspace 108 may provide windows or links to task order data and program and contract data needed for one or more programs of a government agency. For example, virtual workspace 108 may contain links or areas for: specific task orders; functional and program data; operating metrics; financial reporting data; document management systems; status reports; discussion thread; alert systems; employee lists; calendars; news and events; frequently asked questions; quality records; training information; and other web sites.

In addition, the content of virtual workspace 108 may be based on an interactive database system. In some embodiments, delegation of publishing responsibilities for content in virtual workspace 108 may be distributed to users of virtual workspace 108. Accordingly, in some embodiments, a plurality of users can contribute and manage the content of virtual workspace 108. Alternatively, the content of virtual workspace 108 may be managed by a central authority, such as web site administrator. Portal 106 may also be configured to push or broadcast content from virtual workspace 108 to groups of users.

Applications 110 include the software and hardware needed to perform the tasks requested by the users of portal 106. For example, applications 110 may be used for producing labor pricing estimates and quotes, such as those required by a government agency. Applications 110 may include a set of built-in applications as well as links to other applications. In some embodiments, applications 110 may include a predetermined set of applications that are considered suitable for programs of a government agency. For example, the set of predetermined applications may include applications for: news and announcements; calendars; contacts; links; FAQs; text and image files; search tools; a directory; metric data; forums; and status logs. Portal 106 may also provide links in virtual workspace 108 to other systems that are external, such as systems that support financial functions, property and logistics, document management, pricing and training functions.

Applications 110 may be implemented based on well known hardware and the software of applications 110 may be written in a variety of languages, such as Java, XML, C++, Visual Basic, etc. However, the present invention is not limited to these languages and protocols, and others can be used.

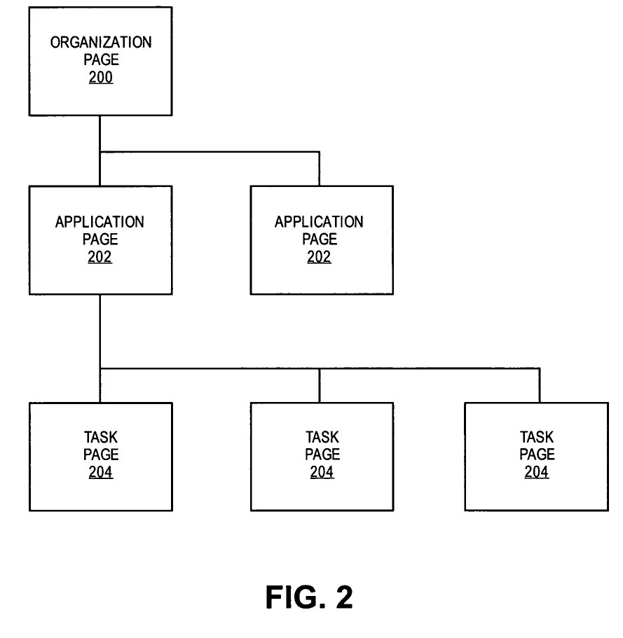

FIG. 2 shows an exemplary hierarchy of web pages that may be provided by portal 106 that is consistent with embodiments of the present invention. Portal 106 may be configured with pages in virtual workspace 108 that are organized around a theme and hierarchy. In the embodiment shown, portal 106 is configured for a government agency and may provide three types of web pages: an organizational page 200, an application page 202, and a task page 204. Organizational pages 200 may represent a functional organization of a government agency that is related to a contract (e.g. Safety, Security, and Finance). Application pages 202 are designed to provide access or an introduction to an online application, such as one of applications 110. Task pages 204 present the steps in a task or process much like a task wizard.

In the embodiment shown, each page type has a specific purpose. Organizational pages 200 are designed to present a large amount of diverse content relating to a common theme for a government agency. Application pages 202 are designed to ensure a user is accessing the correct application of applications 110 and that the user has the appropriate prerequisites for accessing this application. Task pages 204 are similar to applications pages 202, but focus squarely on a particular task at hand with little or no extraneous content. In some cases, task pages 204 may open in a new browser window and be devoid of headers, footers, and navigation items, except those navigation items pertaining to the task itself.

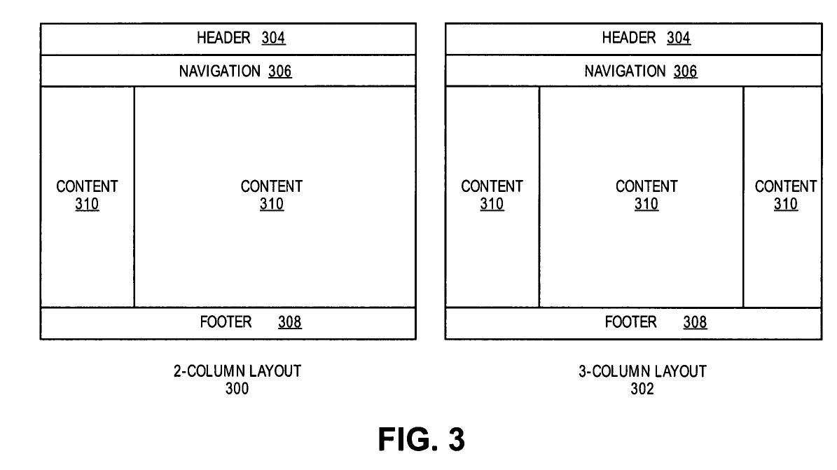

As noted, pages of portal 106 that are displayed for virtual workspace 108 may be based on a common template. FIG. 3 shows exemplary templates for these web pages. For example, templates 300 and 302 may each include a header 304, a navigation area 306, a footer 308, and content areas 310 that are divided into 1, 2, or 3 columns.

Header area 302 may be common to all pages of virtual workspace 108 and may include information, such as a logo, a title for portal 106 or virtual workspace 108, and general links (e.g. Home, Help, Search, My Profile). Navigation area 304 may be configured as a common tabbed structure. In some embodiments, the tabs of navigation area 304 can be personalized based on the user's identify and roles. Footer area 306 may be common to all pages of virtual workspace 108 and may include various legal notices (e.g. copyright, privacy, and terms of use), contact information, and more navigation elements.

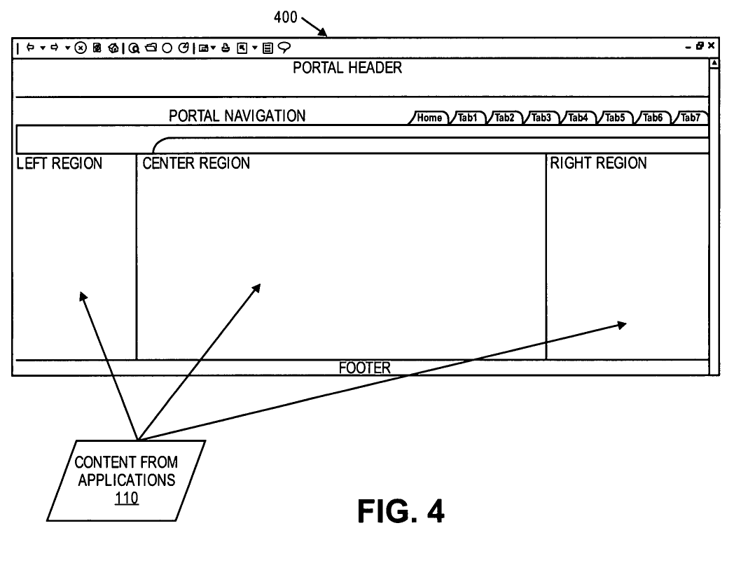

FIG. 4 shows an exemplary web page that is based on template 302 shown in FIG. 3. As shown, a page 400 may present various content in regions 402, 404, and 406, for example, based on applications 110. As noted, applications 110 may be implemented using portlets in some embodiments. Portlets may be as simple as an HTML renderer or as complex as a customized chart generated from dynamic database values. In page 400, a user's identity and roles may personalize the links displayed in content regions 402, 404, and 406, and the tabs displayed in navigation area 306.

In some embodiments, content regions 402, 404, and 406 are initially populated with links to one or more of applications 110 based on the user's role. By default, page 400 may be configured to display eight links, but this setting is also configurable by the user. In addition, the User may personalize other items of page 400, such as add links manually, sort links, set the number of links to display

When a user is removed from a role, the links to one of applications 110 associated with that role may be removed automatically by portal 106, unless that link are associated with another role of the user. When a user is added to a role, portal 106 may add the links to applications 110 associated with the new role to the list of available links, for example, in page 400. Portal 106 may notify the user that additional links are available via a notification portlet and/or a small graphic. The addition or subtraction of available links may be role driven and does not require manual configuration by the user nor an administrator.

Other features and embodiments of the invention will be apparent to those skilled in the art from consideration of the specification and practice of the invention disclosed herein. It is intended that the specification and examples be considered as exemplary only, with a true scope and spirit of the invention.

What is claimed is:

1. An integrated information management system, said system comprising:
a set of predetermined applications related to managing information of a government program; and
a web portal that renders a set of web pages that are linked to each of the set of predetermined applications.

2. The system of claim 1, further comprising:
a client that is configured to interface the web portal.

3. The system of claim 2, wherein the client comprises a browser application.

4. The system of claim 1, wherein the web portal is configured to provide a plurality of identifiers and passwords for a user to the predetermined set of applications.

5. The system of claim 1, wherein the web portal comprises a hierarchy of web pages that include pages that represent a functional organization of the government program, pages that link to one of the predetermined applications, and pages that present progress of tasks of the government program.

6. The system of claim 5, wherein the predetermined set of applications includes an application that determines a price for a task order of the government program.

7. The system of claim 5, wherein formats of the web pages in the hierarchy are based on a set of templates.

8. The system of claim 5, wherein the web portal is configured to permit distributed administration of content in the web pages.

9. The system of claim 1, wherein the predetermined set of applications are configured to control access of a user based on a role of the user.

10. A method of integrating management of information related to government programs, said method comprising:
providing an integrated interface that is interoperable with at least a set of predetermined applications that are related to at least one government program at a location accessible from a public network; and
permitting access to a user to the set of predetermined applications through the integrated interface based on information identifying the user and actions requested by the user that are communicated over the public network.

11. The method of claim 10, wherein providing the integrated interface comprises providing a predetermined set of applications that are common to a plurality of government programs.

12. The method of claim 10, wherein providing the integrated interface comprises providing a web portal at a single address that is accessible from the Internet.

13. The method of claim 10, wherein permitting access to the user to the set of predetermined applications through the integrated interface comprises providing a hierarchy of web pages that include pages that represent a functional organization of one of the government programs, pages that link to one of the predetermined applications, and pages that present progress of tasks of one of the government programs.

14. The method of claim 13, wherein the hierarchy of web pages include pages that provide a workspace for the functional organization of one of the government programs.

15. The method of claim 10, wherein permitting access to the user to the set of predetermined applications through the integrated interface comprises:
initiating a session by the user on the integrated interface based on a single login;
determining respective sets of credentials of the user for gaining access to the set of predetermined applications in response to the single login;
permitting the user to access each of the predetermined set of applications based on the using the single login and the respective sets of credentials.

16. The method of claim 15, further comprising:
controlling access of the user within each of the predetermined set of applications based on the role of the user.

17. The method of claim 10, wherein permitting access to the user to the set of predetermined applications through the integrated interface comprises:
providing web pages that include information related to the predetermined applications; and
distributing administrative rights to content in the web pages to a plurality of users of one of the government programs.

18. A portal for integrating management of information related to government programs, said portal comprising:
a processor;
a memory for storing program code capable of configuring the processor, wherein the program code comprises program code for interoperating with a set of predetermined applications that are common to a plurality of government programs and program code for serving web pages that include content from the set of predetermined applications.

19. The portal of claim 18, wherein the program code for serving web pages comprises program code for pages that represent a functional organization of one of the government programs, pages that link to one of the predetermined applications, and pages that present progress of tasks of one of the government programs.

20. The portal of claim 18, wherein the memory further comprises program code for interoperating with at least one additional application over a network.
